(19) United States
(12) Patent Application Publication
(10) Pub. No.: US 2016/0005002 A1
(43) Pub. Date: Jan. 7, 2016

(54) Generating Tasks

(71) Applicant: Google Inc., Mountain View, CA (US)

(72) Inventor: Benjamin Albert Azose, Menlo Park, CA (US)

(21) Appl. No.: 14/322,803

(22) Filed: Jul. 2, 2014

(51) Int. Cl. G06Q 10/10

(52) U.S. Cl. CPC G06Q 10/1093

(57) ABSTRACT

Methods, systems, and apparatus, including computer programs encoded on a computer storage medium, for generating tasks. One of the methods includes receiving a user request from a user device to generate a notification associated with a first resource presented on the user device. Information associated with the notification, including a first resource identifier of the first resource, is determined from the user request. A notification time identifying a time to provide the notification to a user of the user request is obtained. A selectable identifier to include in the notification from the information is determined. The information, selectable identifier, and notification time are associated with a user account of the user.

### BACKGROUND

A user can receive resources, e.g., documents or webpages, over a network, e.g., the Internet, for display on a user device. The resource can include information regarding events, e.g., concerts, baseball games, operas, and include information relevant to the event, e.g., time of the event, location of the event, cost of the event.

The user can input dates of events into a calendar. The calendar can remind the user about the event on the date of the event, or remind the user at a time identified by the user.

### SUMMARY

This specification describes technologies relating to generating tasks.

In general, one innovative aspect of the subject matter described in this specification can be embodied in methods that include the actions of receiving, from a user device, a user request to generate a notification associated with a first resource presented on the user device; determining, from the user request, information associated with the notification comprising a first resource identifier of the first resource; obtaining a notification time identifying a time to provide the notification to a user of the user request; determining a selectable identifier to include in the notification from the information; and associating the information, selectable identifier, and notification time with a user account of the user.

These and other embodiments can each optionally include one or more of the following features. Receiving a user request comprises: receiving the user request in response to the user selecting an object displayed on an application that is displaying the first resource. The notification is a reminder to view the first resource at the notification time. Determining information associated with the notification from the user request comprises identifying, from the user request, text entered on a form of the first resource by the user. The actions include obtaining the text entered by the user in one or more fields of the form on the first resource; associating the text with the user account of the user; providing the notification to the user; after providing the notification, obtaining information identifying that the user has selected the selectable identifier included in the notification; and providing the first resource with the user entered text in one or more fields of the first resource to the user. The actions include obtaining the text entered by the user in one or more fields of the form on the first resource; associating the text with the user account of the user; providing the notification to the user, wherein the notification includes the text as embedded information. Determining information associated with the notification from the user request comprises identifying a second resource identifier of a second resource presented on the user device. The actions include associating the second resource identifier with the user account of the user; providing the notification to the user, wherein the notification identifies the first resource identifier and the second resource identifier. Obtaining the notification time comprises: determining, from the first resource, a plurality of candidate notification times; providing the plurality of candidate notification times for presentation on the user device; and receiving a user selection of the notification time from among the candidate notification times. Receiving a selection of the notification time comprises: providing, for presentation on the user device, a field for the user to enter the notification time; and receiving the notification time. Obtaining the notification time comprises: extracting the notification time from the first resource. The actions include identifying, from the user account, one or more additional user devices associated with the user account; and providing the notification to the one or more of the additional user devices at the notification time. The actions include identifying, from the user account, an e-mail account of the user; and providing the notification in an e-mail to the e-mail account. The actions include obtaining, at the user device, a respective subject of each of a plurality of resources presented on the user device, wherein the plurality of resources include the first resource; determining that the subjects are related; and including respective resource identifiers of each of the plurality of resources in the user request.

Particular embodiments of the subject matter described in this specification can be implemented so as to realize one or more of the following advantages. A user can view a webpage in a web browser and automatically have a notification generated by a system to prompt the user to perform a task related to the webpage, e.g., a reminder to view the webpage again at a particular time, or an action to be taken on the webpage at a particular time. The user can request that the notification be generated in the user interface that is providing the web browser. This allows for the user to easily request notifications referencing a particular resource, e.g., a webpage, or content about a resource, without having to manually enter information referencing the resource into a calendar and setting a date. For instance the webpage can be related to an item for sale at a specific date, and the user might request a notification to view the webpage again at the date when the item first becomes available.

Furthermore, the notification can include information extracted from the webpage, e.g., text entered into a form of the webpage by the user. Upon providing the notification to the user, the system can automatically populate the text back into the form of the webpage. The user can then finish entering any remaining information into the form without having to reinsert the previously entered text.

The system can also identify one or more dates from the webpage to include as suggested times to provide one or more notifications. Additionally, the system can obtain information relevant to the resource, including a subject of the domain of the resource, e.g., a domain to buy concert tickets, and information related to an event, e.g., a concert, and include the information in the suggested notification.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example user interface of a user device.

FIG. 2 is a diagram of an example notification generation system.

FIG. 3 illustrates an example process for notification generation.

FIG. 4 illustrates an example process for receiving a notification on a user device.

Like reference numbers and designations in the various drawings indicate like elements.

### DETAILED DESCRIPTION

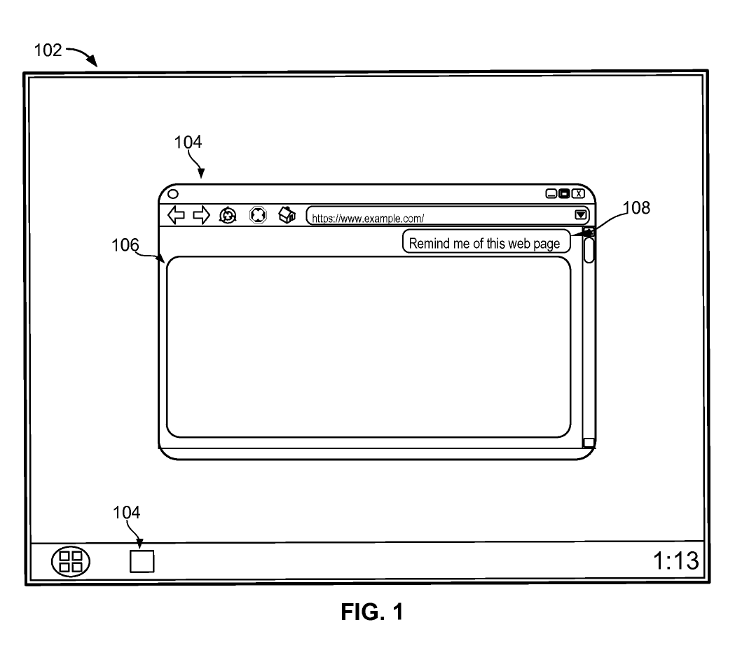

FIG. 1 illustrates an example user interface 102 of a user device. The user device is running an application, e.g., a web browser, that is providing a resource 106, e.g., a web page, for presentation to a user. The application includes a selectable object 108 positioned relative to the top of the application interface indicating that the user can generate a notification reminding the user of the presented resource at a later time, e.g., ‘Remind me of this web page.’ The selectable object 108 is configured to be interacted with by a user, e.g., selected, and provide a user request to a server to create and store a notification to remind the user of the resource at a later date. The selectable object 108 can be the user interface of an add-on or application (“app”) that is a part of, or can communicate with, the application. The add-on or app can be downloaded by the user from a list or database of add-ons or apps. In some implementations, the user interface of the add-on or app can be in a separate window than the window containing display data from the application, and can be configured to remain on top of the application window, e.g., visible to the user. In some implementations, the user interface of the add-on or app can be in the same window as the window containing display data generated from the application, e.g., the application can generate display data for the application and the add-on or app, or the application can generate display data for the application and receive display data generated from the add-on or app and display both. The selectable object 108 can be positioned to be outside of the boundaries of the resource, but contained within the application, e.g., contained within the boundaries of a window displaying the application as depicted in FIG. 1. In this way the user can easily select an object in the application that is also displaying the resource, to provide a user request to generate a notification associated with the resource.

The example interface of FIG. 1 illustrates a user selectable object to generate a notification for the resource. Other techniques can be used to trigger the generation of notifications, including different types of notifications, as will be described in greater detail below. For example, a notification can be triggered based on an analysis of content of the resource such that the user is prompted with suggested notifications associated with the content. In another example, the user can be prompted with a suggested notification in response to other user interaction with the resource, for example, selecting particular objects in the resource or inputting content into one or more fields.

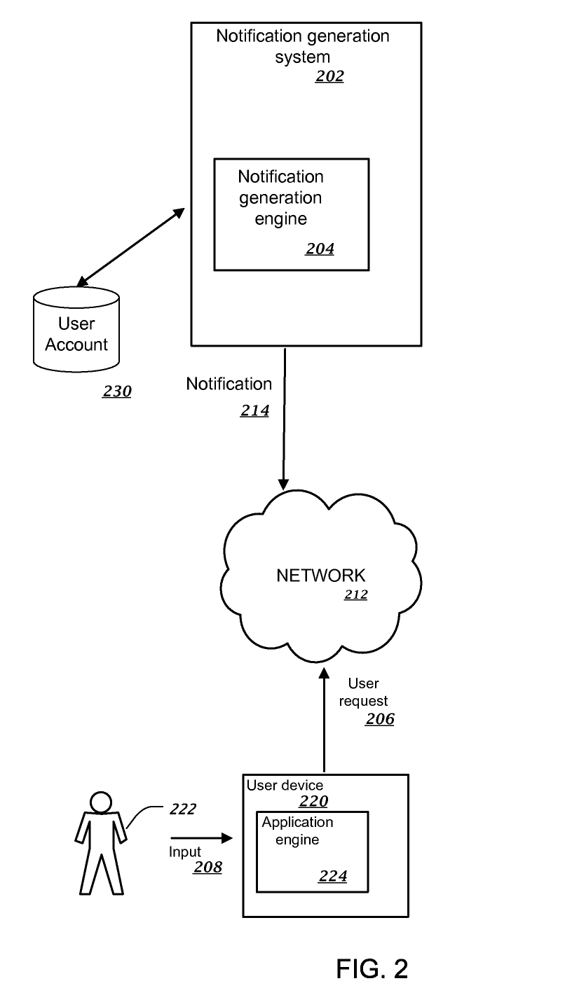

FIG. 2 is a diagram of an example notification generation system 202. The notification generation system 202 includes a notification generation engine 204, and is in communication with one or more user devices 220, e.g., mobile phone, tablet, hybrid laptop, laptop, or computer, associated with a user 222 through a network 212, e.g., the Internet.

The notification generation engine 204 generates and stores notifications associated with one or more resources, e.g., webpages, that a user 222 has open in an application, e.g., a web browser, on the user device 220. The user 222 can have a resource displayed in the application, e.g., a web browser, and request to be reminded of the resource at a later time. For instance, the resource can include content describing a concert, e.g., a ticket website. The user 222 can request a notification to be reminded to view the resource again when tickets to the concert go on sale, e.g., so that the user can purchase one or more tickets when they become available.

The notification generation system 202 can receive a user request 206 to generate a notification associated with a resource displayed on an application of the user device 220. The user request 206 can include various types of data including, for example, a uniform resource locator (URL) of a website, text entered by the user 222 in one or more fields presented by the resource, or application information, e.g., other resources the user has open in the application, e.g., web browser. Upon receiving the request, the notification generation system 202 can generate the notification, e.g., notification 214, and store the notification as associated with a user account 230 of the user 222. The notification can be provided later to a user device associated with the user account 230.

The user device 220 includes an application engine 224. The application engine 224 is configured to provide a user request 206 to the notification generation system 202. Additionally the application engine 224 can automatically prompt the user 222 to provide a user request 206 to the notification generation system 202, e.g., the prompt can be automatically provided upon the user 222 viewing certain resources or subjects of resources. In some implementations, the application engine 224 obtains the subject information from an outside computing system that stores subjects of domains or resources. Additionally, the application engine 224 can determine a candidate subject of the resource, e.g., by identifying text in a large font, or a repeated distinct phrase, and provide the candidate subject to an outside computing system to obtain information about the candidate subject

The application engine 224 can be software executing on the user device 220, and in some implementations the application engine 224 can be an application (“app”) or an add-on of the application, e.g., a web browser. The app or add-on can be downloaded from a database or listing of apps or add-ons, and can interact with the application to obtain identifiers of one or more resources presented by the application or text entered by the user in one or more of the resources.

The user device 220 can receive an input 208 from the user 222 indicating a user request to generate a notification associated with a resource displayed on the user device 220. The input 208 can be an interaction with a selectable object, e.g., selectable object 108, displayed in an application providing the resource, e.g., a click, swipe, double tap on a button, an input gesture, e.g., a cross, a circle. The input 208 can also be a user selection of a particular menu item in the application interface or a menu item associated with particular content, e.g., responsive to a user input such as a “right-click.” The input 208 can also be speech from the user 222 identifying that the user 222 wants to generate a notification.

After the notification generation system 202 receives the user request 206, the notification generation engine 204 can determine information associated with a notification 214 to provide to the user device 220. For instance the user request 206 can include information identifying the resource associated with the user request 206. The notification generation engine 204 can also obtain information identifying a subject of the resource, or a subject of the domain of the resource, to later include in the notification 214.

The user request 206 can include user entered text in a resource, e.g., text entered into one or more fields of a form included in the resource. In some implementations, the notification generation engine 204 can receive the resource with the user entered text, e.g., the underlying code of the resource, e.g., HTML, JavaScript, XML, coupled with the text.

Additionally, the user request 206 can include information identifying other resources the user 222 has previously or concurrently received for presentation on the user device 220, e.g., a web browser session identifying tabs of a web browser or a history of previously retrieved resources.

The notification generation engine 204 can obtain a notification time that identifies a time to provide the notification 214 to the user 222. In some implementations, the notification generation engine 204 can obtain the resource and extract candidate notification times from the resource. The notification generation engine 204 can provide the candidate notification times to the application engine 224 for presentation on the user device 220. The notification generation engine 204 can further receive a user selection of a notification time for the notification 214. In some other implementations, the application engine 224 can extract the candidate notification times from the resource, provide the candidate notification times for presentation on the user device 220, receive a user selection of a notification time, and provide the notification time to the notification generation engine 204.

The notification generation engine 204 can then determine a selectable identifier, e.g., a hyperlink, to include in the notification 214. The selectable identifier is determined from the information associated with the notification 214, e.g., one or more of an identifier of the resource, user entered text, or an identification of other resources presented on the user device 220. For example, if the information associated with the notification 214 is an identifier of the resource, the notification generation engine 204 can determine that the selectable identifier should identify the resource, e.g., a hyperlink identifying the URL of the resource.

In another example, if the information associated with the notification includes user entered text, e.g., form filled data, the selectable identifier can be an identifier including a link that directs the application to the notification generation system 202. Upon receiving information that the user selected the selected identifier, the notification generation engine 204 can provide the information, e.g., the user entered text or other resources, to a user device associated with the user account 230 of the user 222. For instance, the notification generation engine 204 can provide the resource, e.g., the underlying code of the resource, to the application engine 224 with the user entered text already filled in.

In some implementations, if the information associated with the notification includes user entered text, the selectable identifier can be an identifier of the resource. The notification generation engine 204 can include the user entered text in the notification 214, e.g., as embedded information in the notification 214. Upon selecting the identifier, the application engine 224 can obtain the user entered text from the notification 214, and insert the user entered text into the resource, e.g., as a form autofill.

Additionally, the notification generation engine 204 can provide the one or more resources the user previously had open in the application, e.g., a web browser. The selectable identifier can be an identifier to the notification generation system 202. Upon receiving information that the user selected the selectable identifier, the notification generation engine 204 can provide the one or more resources to a user device associated with the user account 230 of the user 222. The notification generation engine 204 can provide the underlying code of the resource to the application engine 224.

In some implementations if the information associated with the notification includes the one or more resources, the notification 214 can include identifiers of the one or more resources in the notification 214, e.g., as embedded information. The application engine 224 can obtain the one or more identifiers and present each identifier in the application, e.g., as a separate tab in a web browser.

The notification generation system 202 can store the determined information associated with the notification 214, the notification time, and the selectable identifier, so that the notification 214 is associated with the user account 230 of the user 222. Upon the notification time, the notification generation system 202 can provide the notification 214 to one or more user devices associated with the user account 230 of the user. For instance, a particular user device that receives the notification can provide the notification as a prompt or pop-up displayed on the user device, e.g., in a web browser. Furthermore, the notification generation system 202 can provide the notification as an e-mail to an e-mail account associated with the user account 230. Also the notification generation system 202 can provide the notification as a push notification, e.g., on a mobile device associated with the user account 230.

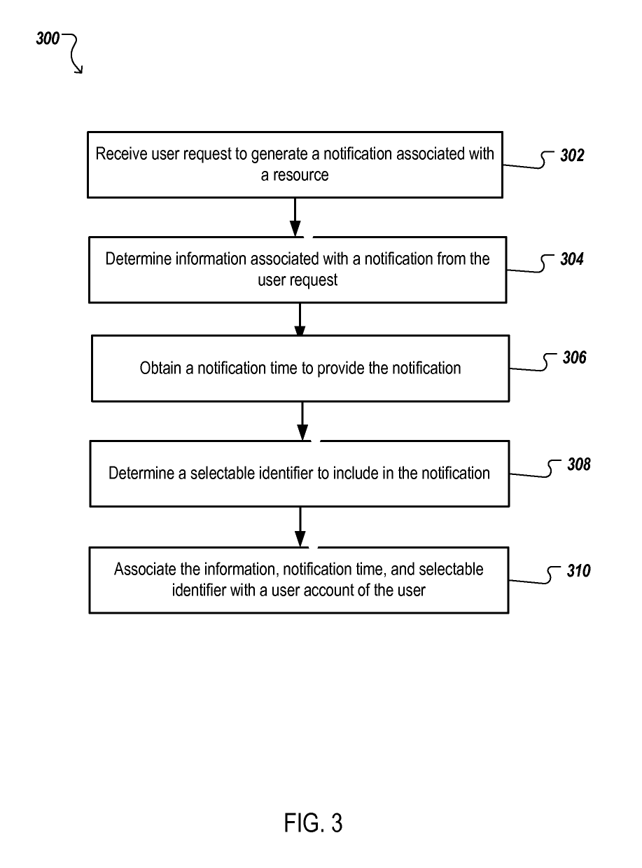

FIG. 3 illustrates an example process 300 for notification generation. For convenience, the process 300 will be described as being performed by a system of one or more computers located in one or more locations. For example, the notification generation system 202 of FIG. 2, appropriately programmed in accordance with this specification, can perform the process 300.

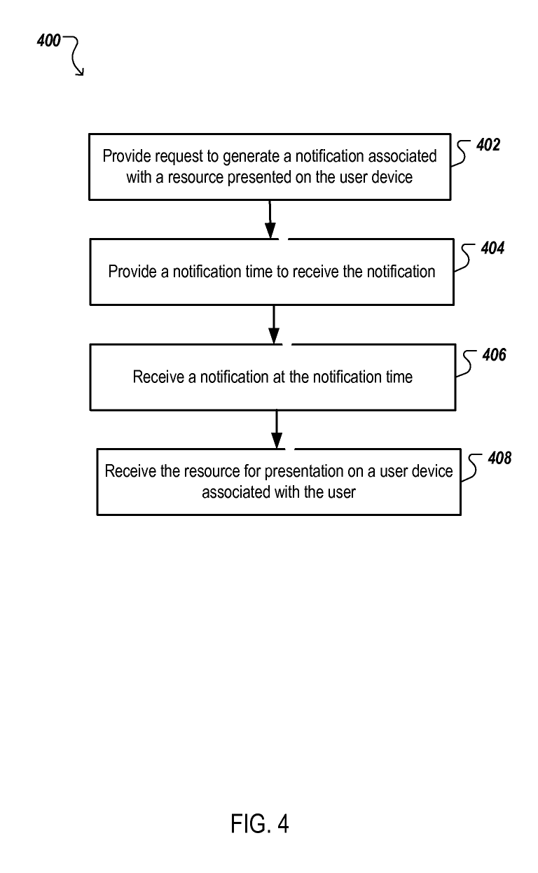

The system receives a user request to generate a notification associated with a resource displayed on a user device (step 302). The system is configured to receive information from, and provide information to, software executing on the user device that can communicate with or be a part of an application, e.g., an add-on or application (“app”) of a web browser. Providing information from the user device to the system is described below, with reference to FIG. 4.

The received user request can include an identifier of the resource, e.g., a URL of a website. The user request can include a description of the resource, e.g., the user can identify why he/she wants to generate the notification. In some implementations, the user request can include text entered into the resource by the user, e.g., one or more fields of a form included in the resource. The user request can include the text coupled with respective identifiers of locations the text was entered into, or the user request can include the underlying code of the resource with the user text inserted, e.g., HTML code. Providing user entered text from the user device to the system is described below, with reference to FIG. 4. In yet some other implementations, the user request can also include identifiers of multiple resources that the user had open for presentation in the user device, e.g., multiple tabs of a web browser.

The system determines information associated with the notification from the user request (step 304). The determined information includes, for example, the resource identifier, e.g., a URL of a webpage, user entered text to the resource, multiple resource identifiers associated with a user session, or user provided description associated with the request. In some implementations, the system can access the code of the resource, e.g., HTML, JavaScript, XML, and identify text associated with titles or headings in the code to include in the determined information. Additionally, the system can obtain a subject of the domain of the resource to include in the notification from an outside computing system, described above with reference to FIG. 2.

In some implementations the system can include text associated with a user account of the user, e.g., address, phone number, name, in the user entered text. The system can identify a form that the received user entered text was inserted in, and identify any fields of the form that correspond to text associated with the user account. For instance, if a field of the form is labeled “Address”, the system can obtain address data from the user account, and include the address data, and an identifier of a location to insert it in the form, with the user entered text.

The system obtains a notification time that identifies a time to provide the notification to the user (step 306). The system can access the resource identified by the determined information from the user request, and extract one or more candidate times from content included in the resource. To extract one or more times the system can use keyword or pattern matching to determine any series of text/number characters indicative of date. For instance the system can look for ‘[##]/[##]/[####]’ in text included in the resource to identify a date. Additional text in proximity to the identified date can be used to provide context for the notification. For example, a resource can describe concert information for multiple concerts by different artists. The context information can be used to generate notifications for particular artists with the correct associated date information based on the context of text in proximity to the determined dates. Furthermore the system can obtain a regular expression for times, e.g., a series of characters that form a search pattern, and apply the regular expression to the resource.

The system can provide the one or more candidate notification times to the user device for presentation. The user can select from among the one or more candidate notification times and the user device can provide the selection to the system. In some implementations, the system provides the one or more candidate notification times for presentation in order of time, e.g., the time soonest to the present time is displayed on top. In some other implementations, the system uses secondary characteristics of the resource, e.g., size of the text of an identified time, font of an identified time, whether an identified time is in bold or italics, and so on, to determine an order of presentation. The system can also determine how close text identifying a time is to text that has a greater font than the remainder of the text included in the resource, or to text that is bold or italic. For example, the system can identify a time that is closer than the other identified times to large font text, e.g., text that states “See Lead Belly at Thee Parkside!” The system can provide the closest time to the large text as the top suggested notification time to provide to the user for presentation on the user device.

Additionally, the user can elect not to select a time from the candidate notification times, and instead enter a different time. The system can provide a window for presentation on the user device that includes a form to enter in a time. Additionally the user device can provide a form for the user to enter in a time and to provide the time to the system. The system can receive the user entered time from the user device, and associate it as the notification time with a user account of the user. In some implementations the system can present no candidate notification times, and instead prompt the user to enter a notification time.

In some implementations, the system can obtain a time included in the resource from an outside computer system, e.g., a system that has pre-processed resources and identified times, a subject of the resource, events included in the resource, and so on. The system can provide the identifier for the resource to the system, and receive one or more times associated with the resource.

In some other implementations, the system can receive a time to provide the notification from the user device. The user device can be configured to extract times from the resource, or the user device can receive a time entered by the user, described below with reference to FIG. 4.

The system determines a selectable identifier to include in the notification (step 308). The selectable identifier e.g., a hyperlink, can be determined by the system to identify the information associated with the notification that is stored in the system. Additionally, the selectable identifier can be associated with the user account of the user, such that the system can obtain information only associated with the user. The particular selectable identifier can depend on the type of information associated with the notification. For instance, if the user request only specifies the resource identifier, the system can determine that the selectable identifier should be the resource identifier. The user can then select the selectable identifier which causes the application of the user device to directly request the resource for presentation. However, if the system received other information in the user request, e.g., user entered text or multiple resources the user had for presentation on the user device, the system can include a selectable identifier that can provide the information to the user device.

In some implementations, the selectable identifier directs the user to the system instead of directly to the resource, e.g., if the information stored on the system includes user entered text or identifiers of multiple resources, e.g., a browser session. Upon receiving information that the user was directed to an address corresponding to information stored on the system, the system can provide the information, e.g., the resource with user entered text, or multiple resources, to a user device associated with a user account of the user.

In providing the resource with user entered text, the system can provide the underlying code of the resource with the text already entered, e.g., a static version of the resource as received by the system. The user can then complete entering text in the resource, and select an object, e.g., button, in the resource to provide the entered information to the domain of the resource.

In some other implementations, the selectable identifier can be the resource identifier, and the provided notification can include the user entered text, e.g., as embedded information. The user device that receives the notification can obtain the user entered text from the notification and insert it into the resource, e.g., as a form autofill. Additionally the system can provide the user entered text with identifiers of locations the text was inserted into, e.g., the identifiers can be related to tags, e.g., HTML input tags, included in the resource. Obtaining user entered text from a notification is described below, with reference to FIG. 4.

In providing multiple resource identifiers, e.g., a prior browser session of a web browser, the system can provide the underlying code of the resources to a user device associated with a user account of the user. In some other implementations, the notification can include information identifying the multiple resource identifiers, e.g., as embedded information. The selectable identifier in these implementations can be an identifier to the user device that received the notification to obtain the multiple resource identifiers from the notification and provide them for presentation on the user device, e.g., as respective tabs of a web browser. Additionally, the selectable identifier can include an identifier that directs to an address corresponding to the system. The system can store information identifying that the user selected the selectable identifier, and either provide a signal to the user device to present the multiple resources, or the user device can automatically present the multiple resources upon the user selection.

In some implementations, the system determines whether the user should receive the multiple resources, e.g., the browser session. That is, the system can determine whether the user is likely doing research on a particular subject, e.g., a scientific, literary, or art subject, and determine to provide the multiple resources back to the user. Determining whether the user is likely doing research is described below, with reference to step 402 of FIG. 4.

In some implementations, the selectable identifier directs the user device that received the notification to an outside computing resource that can provide a signal to the system identifying the user selected the selectable identifier. In these implementations, the system provides either the user entered text or multiple resource identifiers to the user device, as described above.

In some implementations, the selectable identifier identifies the type of information to provide from the system to the user device. For instance a particular selectable identifier can be associated with providing user entered text, e.g., the identifier can include ‘user_text’ in it, and another selectable identifier can be associated with providing multiple resources to the user, e.g., the identifier can include ‘m_res’ in it. The system can receive information identifying that the user was directed to the particular selectable identifier, obtain the respective information and provide it to the user as described above.

The system stores the information associated with the notification, including the notification time to provide the notification, and the determined selectable identifier and associates the information with the user account (step 310). The system accesses the user account, e.g., a user account with the system or an outside computing system the system can provide to and receive information from, and associates the information with the user account.

At the notification time, the system can provide a notification to the user. The notification can identify the subject or title of the resource, any user entered description, context determined from the resource, the notification time, and the selectable identifier. The notification can be provided to one or more user devices associated with the user account of the user, and to an e-mail account associated with the user account of the user. In some implementations, the particular user devices and mode of notification are specified by the user, e.g., as notification preferences, to the system.

FIG. 4 illustrates an example process 400 for receiving a notification on a user device. For convenience, the process 400 will be described as being performed by the user device 220 of FIG. 2, appropriately programmed in accordance with this specification.

The user provides a request to generate a notification associated with a resource displayed on the user device (step 402). As described above, the resource can be displayed in an application, e.g., web browser, running on the user device. In some implementations, the application can include or be configured to communicate with another application, e.g., an add-on or application (“app”) of the application. The user device can receive an input from the user indicating the user wants to generate a notification, e.g., be reminded of the resource in the future. The input can include a user interaction with a selectable object displayed on the application of the user device, or the user can speak into the user device.

In some implementations, the user device obtains a subject of the resource, e.g., the user device can provide an identifier of the resource to an outside computing system and obtain a subject of the resource, and determine to prompt the user to generate a request. For instance, if the subject relates to concerts, plays, sporting events, ticketed events of any kind, the user device can prompt the user to request a notification. For example, the domain can be related to a specific music festival, and the resource can be a webpage included in the domain. In another example, a domain can be directed toward different concerts, and the resource can be a specific concert. The outside computing system can obtain subjects from domains from a variety of sources including advertising information associated with the domain, search result information associated with the domain, or meta tags included in the code of resources in the domain that identify information to a search engine. The user device can provide the resource identifier to the outside computing system, and obtain information identifying that the domain is directed toward concerts.

Additionally the user device can identify that the user is entering text into a form of the resource, and determine whether the user has not finished entering text into the form, or has not submitted the form data, after a threshold amount of time, e.g., 60 seconds, 3 minutes, 10 minutes. Upon a positive determination the user device can prompt the user to generate a notification to complete the form at a later date.

The user device can receive an input from the user in different portions of the user device, e.g., the user device can include a first selectable object and a second selectable object. Each selectable object can be associated with a different type of notification. For instance the first selectable object can be a notification to remind the user to view the resource again. The second selectable object can be a notification to provide multiple resources that the user has open for presentation at a later date.

In some implementations, upon receiving the input, the user device can receive one or more notification options for presentation to the user. The notification options can include one or more pieces of information to include in the notification generated by the system, e.g., the notification generation system 202. For example, the user can select particular notification content to include in the notification including text describing the notification and particular dates for providing the notification. The information can include an identifier of the resource, any user entered text in the resource, or identifiers of multiple resources the user has open in the application, e.g., web browser. Furthermore, the notification can include an area to enter text, e.g., a description of the resource or why the user wants to view the resource again.

In some implementations, upon receiving the user input, the user device can automatically determine information to include in the user request. For instance the user device can determine that the user has entered text in the resource, and elect to include this user entered text in the user request. The user device can provide the underlying code of the resource, e.g., HTML, XML, CSS, JavaScript, with the user entered text in the user request. The user device can also provide the user entered text with respective identifiers that identify the location the text was entered in, e.g., the identifiers can be HTML input tags.

Furthermore the user device can determine that the user might want to include identifiers for multiple resources the user has open in the application, e.g., multiple tabs of a web browser. The user device can make this determination from a subject of the resource displayed on the user device. For instance, the user device can determine whether the user is likely doing research on a particular subject, e.g., a scientific, literary, or art subject, and determine that the user request should include all of the resources. The user device can then determine whether all of the resources relate to the same overall subject as the resource currently displayed. The user device can include identifiers of resources in the user request that relate to the same subject. The user device can further determine whether the number of open resources that relate to a subject is greater than a threshold percentage of the total number of open resources. The user device can then include the resource identifiers that relate to the subject upon a positive determination. In this way the user device can determine that the user is engaged mainly in research, and allows for the user to later receive all open resources that might be relevant to the research. In some implementations, the user device can provide the resource identifiers to an outside computing system, and receive subjects of the resources.

In some other implementations, the user device can provide the multiple identifiers to the system with the user request. The system can then determine whether the user is likely doing research and determine whether to provide the multiple resources to the user, described above with reference to step 308 of FIG. 3.

The user device provides a notification time to provide the notification (step 404). In some implementations, the user device can include a notification time in the request. The notification time can be selected by the user, e.g., input into a text box displayed on the application. In some implementations, the user device can receive one or more candidate notification times determined by the system. The user can select from the candidate notification times, or provide a new notification time, to the system. Additionally the user can enter a time into the user device, and set the entered time as the notification time.

The user device receives a notification from the system at the notification time (step 406). The notification can be received by the user device that provided the request, and can be displayed in the application, e.g., web browser. Additionally, one or more user devices can receive the notification, e.g., user devices associated with a user account of the user. Furthermore, the notification can be received by the user as an e-mail, to an e-mail account associated with the user. The notification can include a selectable identifier, e.g., a hyperlink to the resource, or a hyperlink to the system, for example as described above in step 308 of FIG. 3. Additionally, the notification can include any user entered text or description of the notification, and subject of the resource, e.g., concerts, and a title of the resource, e.g., ‘Robert Johnson at the Neptune’.

In some implementations the notification can include information, e.g., embedded information that can include user entered text, or multiple resource identifiers.

The user device receives the resource for presentation on the user device (step 408). As described above the user device can include any user device associated with a user account of the user. The received notification includes a selectable identifier, e.g., a hyperlink for the user to select. Upon selecting the hyperlink, the application can be directed to the hyperlink. For instance if the hyperlink is the resource identifier, the application can be instructed to provide the resource for presentation to the user. Additionally the notification can include information identifying user entered text, or multiple resource identifiers, e.g., as embedded information. After the user selects the selectable identifier, the user device, e.g., the app or add-on of a web browser, can obtain the user entered text and include it in the resource as an autofill. Similarly, the user device can obtain multiple resource identifiers and open them for presentation on the user device, e.g., as multiple tabs of a web browser.

In some implementations, the hyperlink can direct the application to the system, or a server associated with the system. As described above, the application can include or communicate with an add-on or app of the application. The add-on or app can receive information from the system, e.g., user entered text in a resource, or multiple resource identifiers, and provide the information to the application. For instance, the add-on or app can receive multiple resource identifiers from the system, and provide each resource identifier to the application to open for presentation to the user, e.g., in a separate tab of a web browser. The system can also provide the resource with the user entered text already filled in, e.g., the system can provide the underlying code the resource that includes the user entered text.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, from a user device, a user request to generate a notification associated with a first resource presented on the user device;
determining, from the user request, information associated with the notification comprising a first resource identifier of the first resource;
obtaining a notification time identifying a time to provide the notification to a user of the user request;
determining a selectable identifier to include in the notification from the information; and
associating the information, selectable identifier, and notification time with a user account of the user.

2. The method of claim 1, wherein receiving a user request comprises:
receiving the user request in response to the user selecting an object displayed on an application that is displaying the first resource.

3. The method of claim 1, wherein the notification is a reminder to view the first resource at the notification time.

4. The method of claim 1, wherein determining information associated with the notification from the user request comprises identifying, from the user request, text entered on a form of the first resource by the user.

5. The method of claim 4, further comprising:
obtaining the text entered by the user in one or more fields of the form on the first resource;
associating the text with the user account of the user;
providing the notification to the user at the notification time;
after providing the notification, obtaining information identifying that the user has selected the selectable identifier included in the notification; and
providing the first resource with the user entered text in one or more fields of the first resource to the user.

6. The method of claim 4, further comprising:
obtaining the text entered by the user in one or more fields of the form on the first resource;
associating the text with the user account of the user; and
providing the notification to the user at the notification time, wherein the notification includes the text as embedded information.

7. The method of claim 1, wherein determining information associated with the notification from the user request comprises identifying a second resource identifier of a second resource presented on the user device.

8. The method of claim 7, further comprising:
associating the second resource identifier with the user account of the user; and
providing the notification to the user at the notification time, wherein the notification identifies the first resource identifier and the second resource identifier.

9. The method of claim 1, wherein obtaining the notification time comprises:
determining, from the first resource, a plurality of candidate notification times;
providing the plurality of candidate notification times for presentation on the user device; and
receiving a user selection of the notification time from among the candidate notification times.

10. The method of claim 7, wherein receiving a selection of the notification time comprises:
providing, for presentation on the user device, a field for the user to enter the notification time; and
receiving the notification time.

11. The method of claim 1, wherein obtaining the notification time comprises:
extracting the notification time from the first resource.

12. The method of claim 1, further comprising:
identifying, from the user account, one or more additional user devices associated with the user account; and
providing the notification to the one or more of the additional user devices at the notification time.

13. The method of claim 1, further comprising:
identifying, from the user account, an e-mail account of the user; and
providing the notification in an e-mail to the e-mail account.

14. The method of claim 1, further comprising:
obtaining, at the user device, a respective subject of each of a plurality of resources presented on the user device, wherein the plurality of resources include the first resource;
determining that the subjects are related; and
including respective resource identifiers of each of the plurality of resources in the user request.

15. A system comprising:
one or more computers and one or more storage devices storing instructions that are operable, when executed by the one or more computers, to cause the one or more computers to perform operations comprising:
receiving, from a user device, a user request to generate a notification associated with a first resource presented on the user device;
determining, from the user request, information associated with the notification comprising a first resource identifier of the first resource;
obtaining a notification time identifying a time to provide the notification to a user of the user request;
determining a selectable identifier to include in the notification from the information; and
associating the information, selectable identifier, and notification time with a user account of the user.

16. The system of claim 15, wherein determining information associated with the notification from the user request comprises identifying, from the user request, text entered on a form of the first resource by the user.

17. The system of claim 16, wherein the operations further comprise:
obtaining the text entered by the user in one or more fields of the form on the first resource;
associating the text with the user account of the user; and
providing the notification to the user, wherein the notification includes the text as embedded information.

18. The system of claim 15, wherein determining information associated with the notification from the user request comprises identifying a second resource identifier of a second resource presented on the user device.

19. The system of claim 18, wherein the operations further comprise:
associating the second resource identifier with the user account of the user; and
providing the notification to the user, wherein the notification identifies the first resource identifier and the second resource identifier.

20. A computer program product, encoded on one or more non-transitory computer storage media, comprising instructions that when executed by one or more computers cause the one or more computers to perform operations comprising:
receiving, from a user device, a user request to generate a notification associated with a first resource presented on the user device;
determining, from the user request, information associated with the notification comprising a first resource identifier of the first resource;
obtaining a notification time identifying a time to provide the notification to a user of the user request;
determining a selectable identifier to include in the notification from the information; and
associating the information, selectable identifier, and notification time with a user account of the user.
